(19) United States
(12) Patent Application Publication
(10) Pub. No.: US 2012/0193472 A1
(43) Pub. Date: Aug. 2, 2012

(54) STAIRWAY FOR AN AIRCRAFT

(75) Inventors: Bernard GUERING, Montrabe (FR); Jonathan GUERING, Toulouse (FR)

(73) Assignee: AIRBUS OPERATIONS (Societe par Actions Simplifiee), Toulouse (FR)

(21) Appl. No.: 13/444,591

(22) Filed: Apr. 11, 2012

Related U.S. Application Data
(63) Continuation of application No. 12/599,377, filed on Nov. 9, 2009, now abandoned.

(30) Foreign Application Priority Data
May 31, 2007 (FR) 07 03869

(51) Int. Cl. B64D 11/00; B64D 45/00; B64C 1/14

(52) U.S. Cl. 244/118.6; 244/129.6; 244/129.5

(57) ABSTRACT

A stairway used for gaining access from a theoretically horizontal lower level to a theoretically horizontal higher level, and including a succession of intermediate steps between these two levels. A subassembly of intermediate steps corresponding to the steps closest to the lower level is mobile between a first deployed position at which the lower intermediate steps are in the extension of other intermediate steps, and a raised position at which the lower intermediate steps are in a substantially vertical position.

### CROSS REFERENCE

This application is a continuation of and is based upon and claims the benefit of priority under 35 U.S.C. §120 for U.S. Ser. No. 12/599,377, filed Nov. 9, 2009, the entire contents of which is incorporated herein by reference. U.S. Ser. No. 12/599,377 is a National Stage of PCT/FR2008/000735, filed May 30, 2008, and claims the benefit of priority under 35 U.S.C. §119 from French Patent Application No. 0703869, filed May 31, 2007.

This invention relates to a stairway for an aircraft, in particular a stairway intended to connect two levels in an aircraft cabin or two points of an aircraft and still more particularly a stairway used to connect a day space and a night space in an aircraft.

Document FR-2 873 349 discloses an aircraft having a cabin intended in particular to accommodate seats allowing passengers to travel in seated position and proposes using the upper space of this cabin for arranging berths therein. To access the berths, one (or more) stairway(s) is/are provided. Using a ladder also is suggested.

As for document DE-42 23 320, it shows a stairwell that has a movable component allowing passage in a first position and barring this passage in another position. This document discloses in particular a stairway assembled pivoting between two levels in an aircraft cabin. In a closed position, the stairway blocks an opening implemented in an upper deck and in its open deployed position, the stairway allows passage from a level corresponding to a lower deck to the upper deck. The stairway here can be used as a trapdoor preventing smoke from passing through in case of fire.

This invention has as its purpose to provide a novel layout of a stairway inside an aircraft that makes it possible to make best use of the available space in the aircraft cabin so as to optimize the space that can be used by the passengers.

Another object of this invention is to make it possible to bar access to the zone of the cabin of the aircraft served by the said stairway.

Another objective of this invention is to make best use of the access and evacuation zones of the aircraft.

To this end, this invention proposes a stairway for an aircraft making it possible to access, from a lower level assumed to be horizontal, an upper level also assumed to be horizontal and comprising a series of intermediate steps between these two levels.

According to this invention, a subset of intermediate steps corresponding to the steps closest to the lower level is movable between a first deployed position in which the intermediate steps of the said subset are in the extension of the other intermediate steps and a turned-up position in which the said subset of intermediate steps is in a more or less vertical position.

This stairway thus makes it possible, when it is not being used, to have a reduced space requirement, since its lower steps, corresponding to the steps of the movable subset, are turned up. The space freed up in this way can be used, for example, for passengers walking through during boarding and deplaning.

It is proposed, in an embodiment variant of the invention, that the movable subset of intermediate steps is assembled pivoting in relation to the other intermediate steps which are stationary. This solution makes it possible to have a very simple mechanism that occupies little space. In this variant, on each side of the stationary intermediate steps there are, for example, more or less vertical walls, and in its turned-up position, the movable subset of intermediate steps becomes flush with the vertical edges of the said vertical walls. These vertical walls then delimit, with the stationary intermediate steps, the space for the stairway in its turned-up position.

In order to avoid any effect on the floor of the lower level and thus to best optimize the space in the aircraft, the stairway according to the invention advantageously is assembled suspended from the upper level.

This invention also relates to an aircraft, characterized in that it comprises a stairway such as described above.

Such an aircraft generally comprises at least one access and evacuation door associated with an access and/or evacuation zone. It then is proposed that the stairway be arranged in such a way that the movable subset of intermediate steps is outside the access and/or evacuation zone in its turned-up position and encroaches at least partially on this zone in its deployed position. This arrangement makes it possible to save space by using an area generally unused in an aircraft.

In an aircraft according to the invention, an opening can be implemented in a ceiling above the movable subset of intermediate steps when it is in its deployed position in order to allow and also to facilitate the passage of users of the stairway. A trapdoor also can be provided to close this opening when the movable subset of intermediate steps is in its turned-up position.

This invention also relates to an aircraft characterized in that it comprises:
a deck with an aisle leading to the access to seats, the aisle corresponding to a lower level,
an aisle extending longitudinally in the cabin, raised in relation to the deck and corresponding to an upper level,
berths served by the said aisle,
   and in that the said aisle is accessible by at least one stairway such as described above.

Such an aircraft preferably furthermore comprises presence sensors making it possible to detect the presence of an individual in the zone corresponding to the raised aisle and to the berths.

Details and advantages of this invention will emerge more clearly from the description that follows, given with reference to the attached drawings on which:

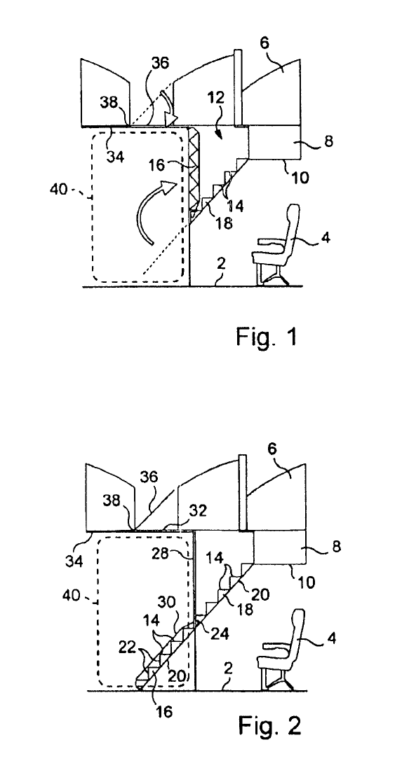

FIG. 1 shows schematically in a side view a stairway according to the invention in turned-up position and placed in its environment,

FIG. 2 corresponds to FIG. 1 with the stairway in deployed position,

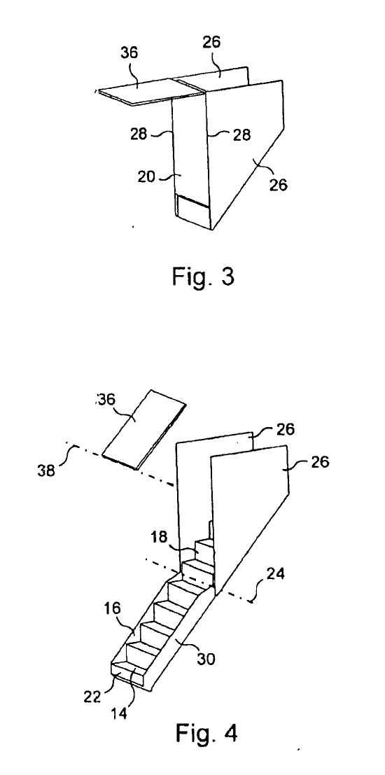

FIG. 3 is a perspective view of the stairway in turned-up position,

FIG. 4 corresponds to FIG. 3 with the stairway in deployed position,

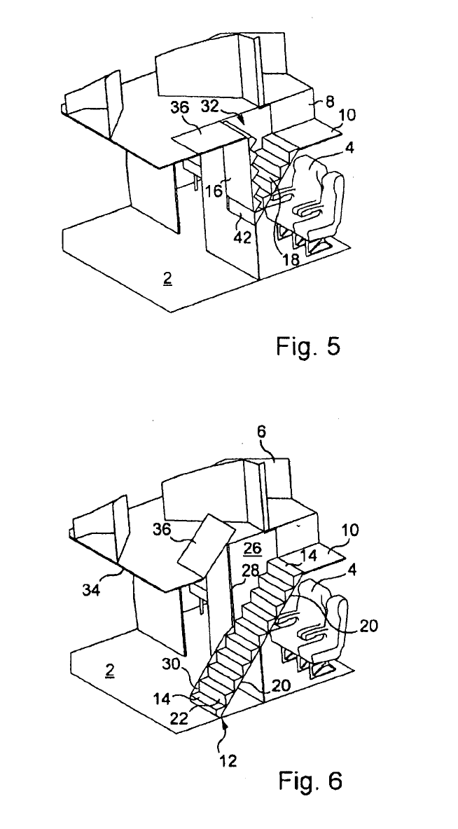

FIG. 5 is a perspective view of the stairway in turned-up position and of its environment shown on FIG. 1, and

FIG. 6 corresponds to FIG. 5 with the stairway in deployed position.

The attached Figures show a stairway located in an aircraft. The latter comprises a cabin arranged on a main deck 2 to which there are fastened seats 4 intended to accommodate passengers. In the upper portion of the cabin are compartments 6 each intended to accommodate a berth (not shown). These compartments 6 are accessible from an aisle 8 the floor 10 of which is raised in relation to the main deck 2. A stairway 12 makes it possible to access the aisle 8 from the main deck 2. This stairway 12 thus makes it possible to connect a first level, or lower level, corresponding to the level of the main deck 2, to a second level, or upper level, corresponding to the level of the floor 10 of aisle 8.

In the remainder of the description that follows, it will be assumed that the main deck 2 defines a horizontal plane and that the floor 10 of aisle 8 is itself also horizontal.

The aircraft in which the stairway described below is located is, for example, an aircraft such as the one described in document FR-2 873 349 or else also in patent application FR-2 903 664.

The stairway 12 has a series of steps 14 that form intermediate horizontal steps between the lower level of the main deck 2 and the upper level of the floor 10 of the corridor 8. In the example shown on the drawings, the stairway 12 has ten steps 14.

The set of steps 14 is divided into two subsets: a movable subset 16 of five steps 14 and a stationary subset 18 with the five other steps 14. The movable subset 16 comprises the five steps 14 closest to the main deck 2 in the deployed position (FIGS. 2, 4 and 6) of the stairway 12. The other steps 14 are stationary and correspond to the steps 14 closest to the floor 10 in the deployed position of the stairway 12.

Each subset of steps has a flat support 20 to which the corresponding steps 14 are fastened. In the embodiment shown, it is seen that a riser 22 is provided for each step 14.

The flat support 20 of the stationary subset 18 is fastened to the floor 10 of the aisle 8. As for the flat support 20 of the movable subset 16, it is assembled pivoting around a first horizontal axis 24, arranged crosswise in relation to the stairway 12. In this way, the movable subset 16 is jointed at the lower end of the stationary subset 18. It can pivot between a first position (FIGS. 2, 4 and 6) in which the two flat supports 20 are more or less in the extension of one another, and a second position (FIGS. 1, 3 and 5) in which the flat support 20 of the movable subset 16 is in a more or less vertical position. In the first position, the steps 14 of the moving subset 16 are in the extension of the steps 14 of the stationary subset 18. There is continuity between the two subsets. In the second position, the steps 14 of the movable subset 16 are more or less one above the other and the movable subset 16 then is in a vertical position, the steps 14 of this movable subset 16 being in inclined position in relation to the horizontal and/or the vertical position.

Vertical walls 26 extend upward from the flat support 20 of the stationary subset 18. These vertical walls 26 have vertical front edges 28 located on the side of the movable subset 16. When the movable subset 16 is in its turned-up position (FIGS. 1, 3 and 5), the flat support 20 of this movable subset 16 becomes positioned between the two front edges 28 of the vertical walls 26.

As is seen on the Figures, side cheeks 30 extend on both sides of the steps 14 of the movable subset 16. These cheeks have a height corresponding more or less to that of the steps 14 and risers 22 of this movable subset 16. When the movable subset 16 changes over from the deployed position (FIGS. 2, 4 and 6) to its turned-up position (FIGS. 1, 3 and 5), the side cheeks 30 find a place inside the vertical walls 26.

Safety guardrails (not shown) can be mounted on the side cheeks 30 (or on any other part of the movable subset 16). Guardrails likewise can be provided on the vertical walls 26.

When the movable subset 16 is in its deployed position, it is on the one hand resting on the main deck 2 and on the other hand connected to the stationary subset 18, itself fastened to the floor 10. When this subset is in its turned-up position, it is still attached to the stationary subset 18 at the first horizontal axis 24, but its other end no longer is supported. Locking means (not shown) then advantageously are provided. It involves, for example, means mounted on both the movable subset 16 to be locked and the vertical walls 26.

In order to allow the users of the stairway 12 to pass through when it is in its deployed position (FIGS. 2, 4 and 6), an opening 32 is provided in the ceiling 34 of the zone of the cabin intended to accommodate passengers in seated position.

In order to facilitate the passage of these users, the opening 32 extends to above the movable subset 16 in its deployed position (FIGS. 2, 4 and 6). When the movable subset 16 is in its turned-up position (FIGS. 1, 3 and 5), this opening 32 is still partially visible in the ceiling 34 from the main deck 2. A trapdoor 36 then is provided jointed around a second horizontal axis 38. This second axis corresponds to an edge of the opening 32, for example—as on the drawings—the edge of this opening away from the vertical walls 26. The trapdoor 36 then is movable in a first inclined position (FIGS. 1, 3 and 5) and a second horizontal position (FIGS. 2, 4 and 6).

In a preferred embodiment, as can be seen on FIGS. 1 and 2, at least one stairway 12 of the aircraft is placed at least partially in front of an access and evacuation door 40. In turned-up position (FIG. 1), the stairway 12 in no way comes to encroach on the security zone for access to the door 40. On the other hand, in deployed position (FIG. 2), most of the movable subset 16 is located in this security zone. This makes it possible to save considerable space in the aircraft. In fact, the stairway 12 makes it possible to access a night zone of the cabin, in which berths are located. This zone is accessible only during the flight phases of the aircraft. The security zone therefore is not used for access to the door 40 and then can be used to accommodate a portion of the stairway 12.

In this way, the space wasted when it is not necessary to access the top portion of the cabin (the one in which the berths are located, in the above example), is limited.

The stairway 12 shown on the drawings is a fully suspended stairway. The stationary subset 18 on which the movable subset 16 is jointed and the vertical walls 26, which also can be called side walls, are suspended from the ceiling 34 and from the floor 10 of aisle 8. In this way, space is freed up on the floor on main deck 2.

Before the boarding of passengers into the aircraft, the movable subset 16 of the stairway (or of each stairway of the aircraft) is in turned-up position. If a trapdoor 36 is provided, the latter then is in its closed position, that is, it more or less merges with the ceiling 34.

The passengers who are boarding the aircraft then do not notice, if they do not know about it, the presence of a stairway and of an access to an upper portion of the cabin of the aircraft.

Once the aircraft is in cruising flight phase, the stairway 12 can be put into service in order to allow the passengers who so desire to go to their berth. By acting on an unlocking control panel 42 (cf. FIG. 5), the commercial flight personnel can control the deployment of the stairway 12, or more precisely of its movable subset 16. The maneuver preferably is aided by oleopneumatic jacks that make it possible to compensate for the mass of the movable subset 16.

Prior to landing, the passengers in the upper portion of the cabin are asked to go back to their seats 4 on the main deck 2, and the movable subset 16 of each stairway 12 is turned up to its final vertical position, in which it is provided that locking takes place automatically. The movements of deployment and turning-up of the movable subset 16 of a stairway can be combined with the movement of the corresponding trapdoor 36. A mechanism, for example connecting rods, can connect the movable subset 16 and the corresponding trapdoor 36 in order to synchronize the movements of these movable components.

It also is observed that when the stairway is in its turned-up position (FIGS. 1, 3 and 5), the entire zone to which the stairway 12 allows access when it is in deployed position is closed and therefore no longer is accessible. The stairway 12 here performs the function of both stairway and closure door.

When the stairway or stairways 12 is/are brought into turned-up position, it is preferable to make sure that no one is present in the upper portion of the cabin of the aircraft. Presence sensors (not shown) then can be arranged in the upper zone of the cabin (in which the berths are located) to make sure that this zone is not occupied. In fact, prior to a landing, the passengers must return to their seats and it is necessary to make sure that no passenger remained on his berth. The sensors then can detect a possible presence immediately.

This invention is not limited to the preferred embodiment described above by way of non-limitative example, and the variants suggested. It also relates to the other variants within the capacity of the individual skilled in the art in the context of the claims below.

1. A stairway for an aircraft making it possible to access from a lower level, assumed to be horizontal, an upper level also assumed to be horizontal, and comprising:
a series of intermediate steps between the upper and lower levels,
wherein a subset of intermediate steps corresponding to steps closest to the lower level is movable between a first deployed position at which the intermediate steps of the subset are in extension of the other intermediate steps, and a turned-up position at which the subset of intermediate steps is in a substantially vertical position.

2. A stairway for an aircraft according to claim 1, wherein the movable subset of intermediate steps is assembled pivoting in relation to the other intermediate steps that are stationary.

3. A stairway for an aircraft according to claim 2, wherein substantially vertical walls are located on each side of the stationary intermediate steps, and in its turned-up position, the movable subset of intermediate steps becomes flush with vertical edges of the vertical walls.

4. A stairway for an aircraft according to claim 1, assembled suspended from the upper level.

5. An aircraft, comprising a stairway according to claim 1.

6. An aircraft according to claim 5, further comprising at least one access and evacuation door associated with an access and/or evacuation zone,
wherein the stairway is arranged such that the movable subset of intermediate steps is outside the access and/or evacuation zone in its turned-up position and encroaches at least partially on this zone in its deployed position.

7. An aircraft according to claim 5, further comprising an opening implemented in a ceiling above the movable subset of intermediate steps when the stairway is in its deployed position, and a trapdoor to close the opening when the movable subset of intermediate steps is in its turned-up position.

8. An aircraft according to claim 5, further comprising:
a deck with an aisle leading to an access seat, the aisle corresponding to the lower level;
an aisle extending longitudinally in the cabin, raised in relation to the deck and corresponding to the upper level;
berths served by the aisle, and
wherein the aisle is accessible by the stairway.

9. An aircraft according to claim 8, comprising presence sensors making it possible to detect presence of an individual in the zone corresponding to the raised aisle and to the berths.
